(19) United States
(12) Patent Application Publication
(10) Pub. No.: US 2007/0137454 A1
(43) Pub. Date: Jun. 21, 2007

(54) Dispenser for web material

(76) Inventors: Victor J. DesRosiers, Kinderhook, NY (US); Michael Tucker, Valatie, NY (US); Ronald A. Lanier, Savannah, GA (US); Rudolf Ravlik, Lincolnshire, IL (US)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 10/596,936

(22) PCT Filed: Jan. 25, 2005
(86) PCT No.: PCT/US05/02200

§ 371 Date: Jun. 29, 2006

Related U.S. Application Data
(60) Provisional application No. 60/539,174, filed on Jan. 26, 2004.
(60) Provisional application No. 60/549,431, filed on Mar. 1, 2004.

(51) Int. Cl. B26D 1/04

(52) U.S. Cl. 83/614; 83/649

(57) ABSTRACT

A container is provided for dispensing selected portions of a web material retained on a roll. The container includes a substantially hollow dispenser tube, a track-guided cutting assembly and end caps securing the dispenser and track structure. The dispenser has an elongated opening in a portion of the side wall thereof. The end caps include a groove substantially corresponding to the profile shape of the dispenser, a projection substantially corresponding to the inner diameter of the roll, and a cutter track holder to secure the cutting assembly adjacent the opening in the dispenser.

### FIELD OF INVENTION

The present invention relates to dispensers for web materials, such as foil, plastic film, wax paper, gift wrap paper, etc. In particular, the invention relates to non-rectangular containers having detachable molded end caps forming the lateral ends of the container.

### BACKGROUND OF INVENTION

Various containers are known for dispensing web material. Many of these containers use an exposed serrated edge as the means for cutting the web material once dispensed from the container. These serrated edges have several disadvantages. For example, the sharp, exposed serrated edge can inadvertently cut the user or other material that it contacts. Also, the user must engage the web material with the serrated edge by holding the web material in one hand and the container in the other. This awkward arrangement can lead to adverse results such as ineffective cutting, the web material doubling over itself, and so on.

Some known containers include a track-guided cutting assembly to overcome the problems associated with the use of a serrated edge. These containers have their own set of disadvantages. For example, many of these dispensers require the user to place the cutting assembly onto the container by way of an adhesive. A user could misalign the cutting assembly, which could result in difficulties cutting. The manufacturer could install the cutting assembly onto the container before sale, but the assembly may become disengaged from the container during shipment or storage. Further, the known cutter assemblies require a means to prevent the cutting device from being removed from the assembly, for example, by manufacturing a track with crimping, stops, or the like to prevent removal of the cutting device. These items add sophistication and cost to the manufacturing.

Another disadvantage of some known containers is the lack of a means to secure the roll of web material in the container while still allowing the roll to rotate. Without a means to secure the roll, the roll can be inadvertently pulled from the container as the user is attempting to remove a portion of the material for cutting.

### SUMMARY OF INVENTION

The present invention generally comprises a container for dispensing selected portions of a web material retained on a roll. The container includes a substantially hollow dispenser tube, a track-guided cutting assembly and molded end caps. The dispenser tube has an elongated opening in a portion of the side wall thereof. The end caps include a molded groove substantially corresponding to the profile shape of the dispenser and preferably include a molded projection substantially corresponding to the inner diameter of the roll. The cutting assembly is secured adjacent the elongated opening and is preferably fixed in position by means of the end caps.

Additional features of the present invention include variations in the form of the dispenser, the cutter assembly and the end caps.

### BRIEF DESCRIPTION OF THE DRAWINGS

For the purpose of illustrating the invention, there is shown in the drawings various forms which are presently disclosed; it being understood, however, that this invention is not limited to the precise arrangements and instrumentalities particularly shown.

FIG. 1A is an exploded perspective view of an embodiment of a dispenser as contemplated by the invention.

FIG. 1B is a perspective view of the embodiment of the dispenser of FIG. 1A with a protective sleeve fit over the assembly.

FIGS. 2A and 2B are a front and back view, respectively, of an embodiment of end caps of the invention.

FIGS. 3A and 3B are perspective views of an end cap with a snap-over paper holder in an open and closed position, respectively.

FIG. 4 is a perspective view of a bayonet fitment between an end cap of the invention and a dispenser of the invention.

FIG. 5 is a perspective view of an embodiment of the dispenser that is telescoping and that provides a means to orient the dispenser with an embodiment of end cap.

FIG. 6A is a perspective view of a means of engagement between a cutter track of the invention and an end cap of the invention.

FIG. 6B is a perspective view of further means of engagement between an end cap and a cutter track.

FIG. 7 is a semi-exploded perspective view of a twin pack embodiment of the dispenser.

FIG. 8 is a plan view of two interlocking end caps.

FIG. 9A is a perspective view of a semi-cylindrical embodiment of the dispenser of the invention.

FIGS. 9B and 9C are end views of alternate embodiments of a cutter track attached to the dispenser shown in FIG. 9A.

FIGS. 10A and 10B are perspective views of a pop-up dispenser in a flat position and a upright position, respectively.

FIG. 11 is a perspective view of a further embodiment of a dispenser and an associated support.

### DETAILED DESCRIPTION OF THE DRAWINGS

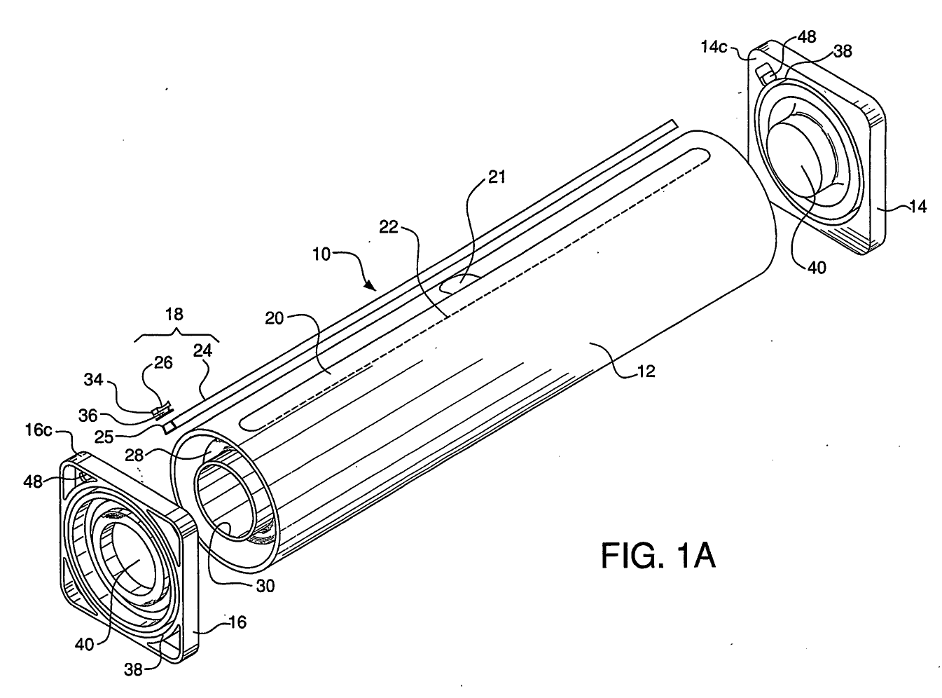

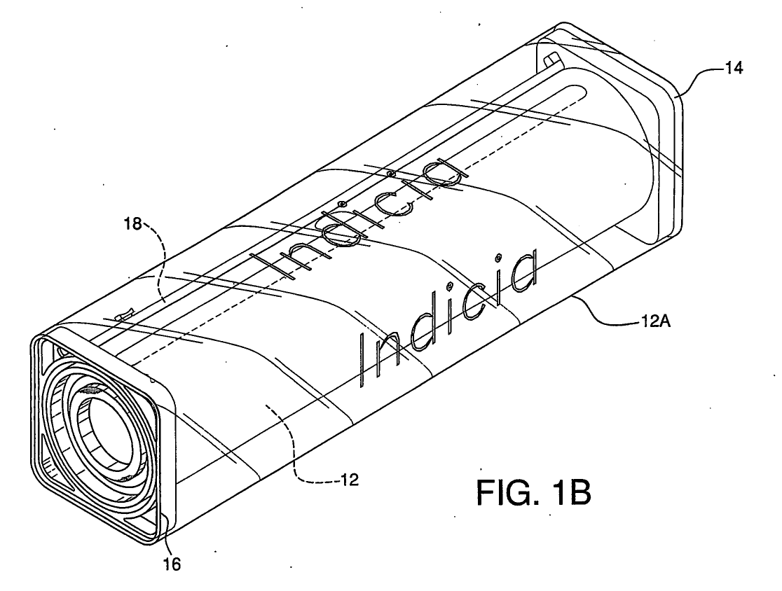

In the drawings where like elements are identified by like numerals, there are shown various embodiments of a container for storing and dispensing rolled web material, e.g., foil, plastic wrap, wax paper, gift wrap paper, etc. The container, as illustrated in FIG. 1A, is identified by the numeral 10 and comprises a dispenser 12, end caps 14, 16, a cutter assembly 18, and a hollow roll 30 of web material 28. Dispenser 12 comprises an elongated opening 20, a perforated strip 22, and a perforated punch tab 21. End caps 14, 16 comprise a dispenser holder 38, a roll support 40, and a cutter track holder 48. The cutter assembly comprises a cutter track 24 and a shearing device 26.

In operation, web material 28 is retained on a hollow roll 30 positioned within dispenser 12. Hollow roll 30 is supported for easy rotation on roll supports 40 formed on end caps 14, 16. A portion of web material 28 is pulled through elongated opening 20 and placed over track 24 of cutter assembly 18. An edgewise cut is made through web material 28 by shearing device 26 as it traverses along the guide of track 24.

Dispenser 12 can be made from a substantially rigid material, e.g., layered paper stock, cardboard, or plastic. Dispenser 12 be made from two plies of 12 pt or thinner material. It is contemplated that a thicker dispenser construction would be more expensive to manufacture but would allow for the container to be reusable, whereas a thinner dispenser construction would be less expensive to manufacture but would be more suitable for merely a one-time-use (or disposable) container.

Dispenser 12 can be transparent, allowing the user to see web material 28 that is positioned in dispenser 12. Transparent dispenser 12 is beneficial for web material 28 such as gift wrap, where the user desires to see the pattern, color, or other visual quality of web material 28 on a larger scale before removing it from dispenser 12. For example, with transparent dispenser 12 the user can see a larger scale sample of a floral pattern or a “Happy Birthday” message before removing web material 28 from dispenser 12. Moreover, transparent dispenser 12 allows the user to see how much web material 28 is left in dispenser 12, allowing the user to gauge what the remaining web material 28 can cover and when it is time to replace the roll.

Decorative marking can be provided on the outside of dispenser 12 to enhance the marketability of the invention and/or to more easily identify the type of web material enclosed in dispenser 12. For example, for Christmas gift wrap paper, dispenser 12 can comprise decorative markings of Christmas trees and snowmen, or dispenser 12 can be tinted green and red. Also, for example, for foil, plastic wrap, or any other kitchen-type web material, dispenser 12 can comprise decorative markings so as to complement a kitchen décor.

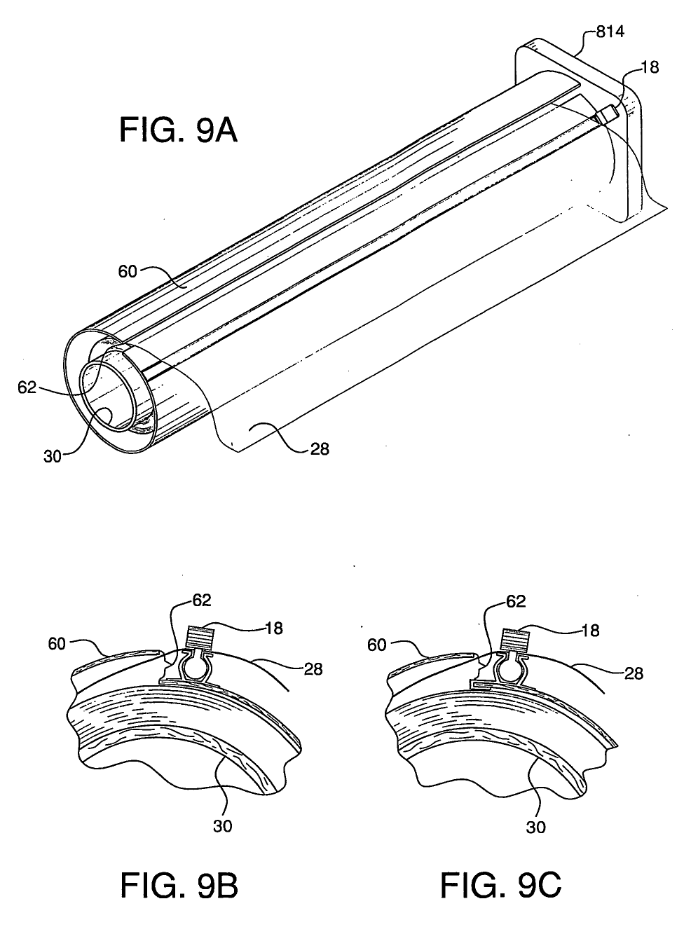

The dispenser can comprise any shape, provided that is capable of accepting a hollow roll of web material 30. Thus, at a minimum, the dispenser must include an area capable of housing the roll of web material. Preferably, the dispenser is tubular-shaped (i.e., having a circular body), as shown in FIG. 1A. The dispenser can also be semi-cylindrical in shape, for example, as shown in the embodiment in FIGS. 9A and 9B, where the body does not have an exactly circular profile or cross-section. The dispenser can have a profile shape that is rectangular, ovular or some other geometrical or non-geometrical shape.

Cutter assembly 18 comprises a cutter track 24 and a shearing device 26. Cutter track 24 has rails 25 for guiding the shearing device 26. Preferably, cutter track 24 is manufactured using a co-extrusion process so as to provide it with a substantially rigid overall construction and a tackiness on rails 25. For example, cutter track 24 can be made from a styrene based elastomer co-extruded on a high impact polystyrene (“HIPS”), a plasticized polyvinyl chloride (“PVC”) co-extruded on a rigid PVC, a tactified HIPS co-extruded on a rigid HIPS, or some other similar construction. Other rubbers, elastomers, and plastics are also contemplated. Alternatively, cutter track 24 can be coated with a material with adhesive qualities. The adhesive qualities allow web material 30 to be temporarily fixed on cutter track 24 to facilitate even cutting with shearing device 26.

Shearing device 26 nests in cutter trick 24 such that once engaged with cutter track 24, shearing device 26 can only be removed by sliding it out of one of the ends of cutter track 24. Shearing device 26 comprises an upper portion 34 and a shearing portion 36. Upper portion 34 can be manufactured from plastic or some other rigid material and can be contoured to accept a human finger so as to facilitate facile movement along cutter track 24. Shearing portion 36 can be in the form of a plastic or metal cutting blade. Further, shearing portion 36 can include a blade that can cut in either direction along the track (i.e., a blade with two sharp edges).

In operation, a portion of the web material is removed from dispenser 12 and is laid across the top surface of cutter track 24. The user then moves upper portion 34 of shearing device 26 along cutter track 24 such that shearing portion 36 cuts the portion of web material 30 from the roll.

Cutter assembly 18 is preferably disposed adjacent a elongated opening 20, which, in the embodiment shown in FIG. 1A, is exposed by removing a perforated strip 22 adhesively attached to the dispenser 12. A punch out tab 21 aids in removing perforated strip 22. Punch out tab 21 also provides the user with a greater area from which the user can grab the web material. The dispenser can be manufactured with the elongated opening 21 but without the perforated strip 22 and the punch out tab 21. For example, a mold for a plastic dispenser can provide for the elongated opening by preventing the plastic from filling the mold in the area corresponding to the elongated opening.

The location of cutter assembly 18 with relation to end caps 14, 16 can be at a circumferential location corresponding to one of corners 14C, 16C of end caps 14, 16 (as shown in FIG. 1A), or alternatively, along one edge of end caps 14, 16 (not shown).

Cutter assembly 18 is preferably secured within container 10 by way of engagement with cutter track holder 48 of end caps 14, 16 as is further described below. Alternatively, cutter assembly 18 can be adhesively bonded to the exterior of dispenser 12.

Container 10 further comprises end caps 14, 16 that close each end of dispenser 12. As illustrated in FIG. 1A, the end caps can have a substantially square outer peripheral profile. A “substantially square profile” includes a profile with four equal sides and with the intersection of each side meeting at a right angle. “Substantially square profile” further includes a profile with, for example, rounded corners and/or side lengths that are not exactly equal. The substantially square profile in combination with the circumferential location of the cutter assembly enables the container to be stacked in a uniform fashion, i.e., without the cutter assembly interfering with packaging and/or display of the dispenser.

In FIG. 1B there is shown the container 10 of FIG. 1A having a protective sleeve 12A surrounding the dispenser body 12 and the cutter assembly 18. The sleeve 12A is contemplated to conform to or otherwise be secured to the periphery of the end caps 14, 16. Advertising or other indicia may be included on the walls of the sleeve 12A. The protective sleeve may be removable or may have an opening therein to provide access to the web material and cutter assembly.

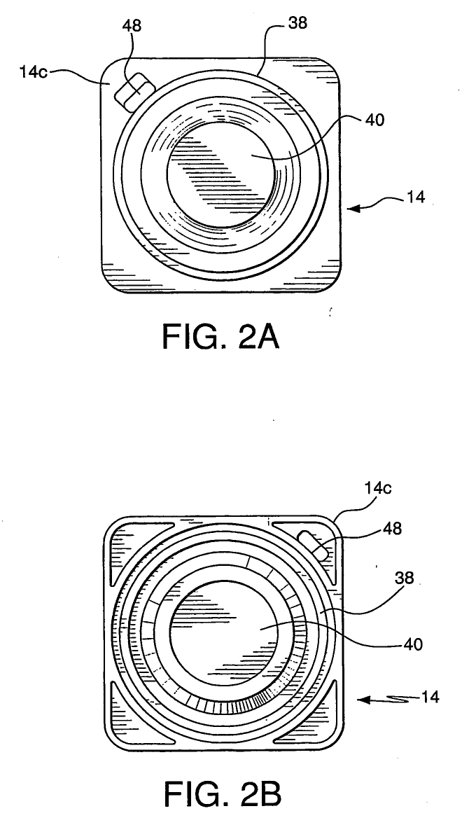

End caps 14, 16 are preferably molded from a material such as plastic. As illustrated in FIG. 2A, the molded configuration of end cap 14 comprises means for accepting dispenser 12, means for accepting hollow roll 30, and means for accepting cutter assembly 18.

FIG. 2B shows the backside of end cap 14 (i.e., the side opposite the dispenser). In an alternative embodiment, the end caps can be manufactured such that both sides of the end cap are as shown in FIG. 2A. That is, both sides can comprise means for accepting a dispenser, means for accepting a hollow roll, and means for accepting a cutter assembly. This two-sided alternate embodiment allows three end caps to support two dispensers. For example, a first end cap and a second end cap can support a first dispenser. Provided that the second end cap is the two-sided embodiment, the second end cap and a third end cap can then support a second dispenser. The result is two dispensers along the same axis supported by only three end caps.

The preferred means for accepting a dispenser comprises a molded groove 38. Molded groove 38 substantially corresponds to the profile shape of the dispenser. For example, molded groove 38 shown in FIG. 2A substantially corresponds to tubular dispenser 12 (and the circular profile of dispenser 12) shown in FIG. 1A. Dispenser 12 is inserted into molded groove 38 such that the dispenser is held in place by a friction interference fit.

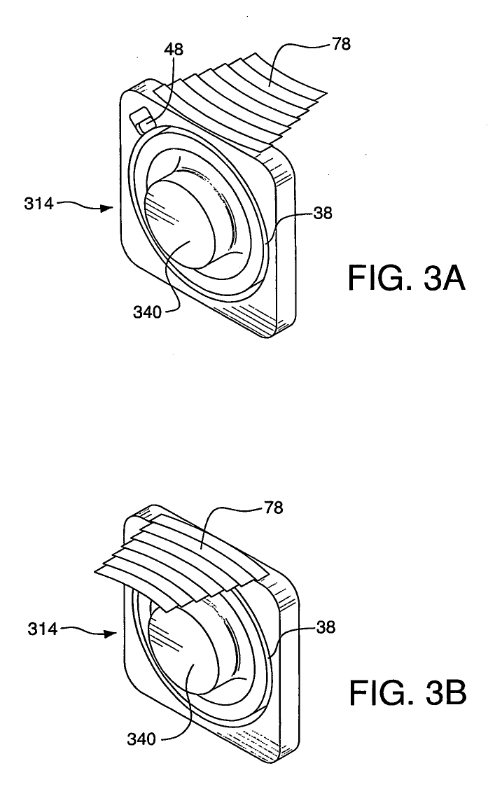

FIGS. 3A and 3B illustrate an alternate means to secure the web material to the exterior of the dispenser, wherein end cap 314 comprises a snap-over holder 78. The holder 78 can be integrally molded with the end cap 314 or it can attached to end cap 314 by way of a spring hinge or similar means. The holder 78 preferably has a curvature to provide for a greater hinge strength. FIG. 3A shows paper holder 78 in an open state. FIG. 3B shows paper holder 78 in a closed state. In operation, a user would keep the holder 78 in the open state until the user desires the web material to be secured (e.g., for cutting or storage). The user would flip the holder 78 from the open state to the closed state causing it to trap the web material against the dispenser. Similar to holder 74, the holder 78 can be adjusted so that the web material is completely immobilized or only partially immobilized. Preferably, the holder 78 is used on both end caps but, alternatively, it can be provided on only one end cap.

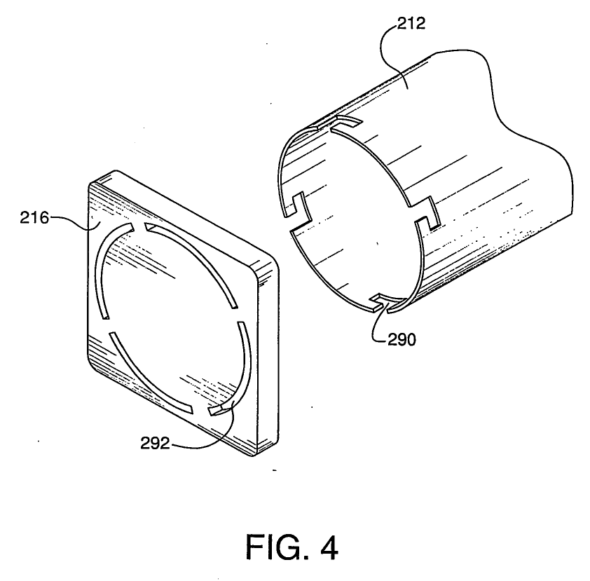

An alternate means for accepting a dispenser uses an interlocking bayonet coupling as shown in FIG. 4. Cylindrical dispenser 212 comprises a female bayonet configuration 290 engaged with a male bayonet configuration 292 of the end cap 216. The interlocking coupling is oriented such that when a user pulls a web material from the dispenser, the coupling is not disengaged, rather the coupling is further secured. The interlocking bayonet configuration increases the stability of the engagement of dispenser 212 and end caps 214, 216.

As is shown in FIG. 1, the preferred means for accepting a hollow roll comprises a roll support 40 in the form of a molded projection that is tapered, such that the end caps can accept hollow rolls with various inside diameters. In operation, supports 40 extend into the hollow portion of the roll. A portion of the inner surface of the roll rests on supports 40 allowing the roll to rotate about supports 40, while at the same time locking the roll in a relatively fixed location (i.e., preventing significant lateral movement).

As shown in FIGS. 1, 2A and 2B, The preferred means for accepting cutter assembly 18 comprises cutter track holders 48 that accept the ends of cutter track 24. The holders 48 may be openings or slots in the wall of the end caps, or may include detents formed to substantially correspond to the profile shape of cutter track 24. For example, for a cutter track with a trapezoid shaped profile, the cutter track holder could be in the shape of a trapezoid, a square, a rectangle, or some other shape that adequately accepts a trapezoid. The engagement fixes cutter track 24 adjacent to dispenser 12. This engagement allows cutter track 24 to be fixed adjacent to dispenser 12 without the use of adhesives or the like. However, the track 24 may also be secured to the dispenser tube with the holders positioned on the end caps to appropriately mate with the combined dispenser and cutting assembly structure.

The engagement of cutter track 24 with cutter track holder 48 also fixes shearing device 26 in cutter track 24. Once shearing device 26 is placed in cutter track 24 and cutter track 24 is engaged with cutter track holders 48 of end cap 14 and end cap 16, shearing device 26 can only be removed by removing one of the end caps. This design reduces the cost and sophistication of manufacturing by allowing cutter track 24 to be manufactured without stops, crimps or other means to maintain shearing device 26 in cutter track 24.

Cutter track 24 can be engaged with end caps 14, 16 as end caps 14, 16 are being attached to dispenser 12. Alternatively, cutter track 24 can be engaged with end caps 14, 16 after both end caps 14, 16 have been engaged with dispenser 12. In this alternative approach, one end of cutter track 24 can be inserted into cutter track holder 48 of end cap 14. Cutter track 24 may then be bowed in the middle so that the other end of cutter track 24 can be inserted into cutter track holder 48 of end cap 16. Once container 10 is assembled, end caps 14, 16 are rotationally fixed relative to dispenser 12 and, consequently, cutter assembly 18.

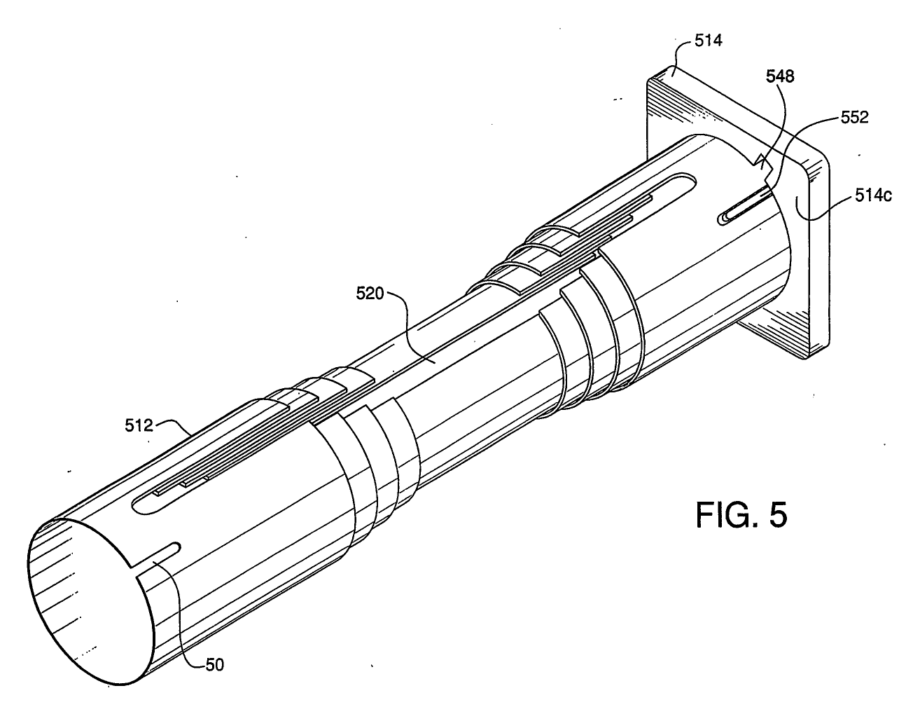

FIG. 5 shows an alternate embodiment of the container with the dispenser 512 comprising notches 50 on either side and end caps 514 (only one being shown in this FIG. 5) having outwardly extending ribs 552. The notches are positioned proximate to the elongated opening 520. The ribs 552 are positioned proximate to the cutter track holder 548 and the end cap corner 514c. The ribs 552 engage the notches such that the orientation of dispenser 512 is fixed. In this fixed orientation, the elongated opening 520 is positioned proximate to the cutter assembly (not shown) once the cutter assembly is engaged with the cutter track holder 548.

FIG. 5 also shows that the dispenser is telescoping in nature to allow the container to be used with web material that is on different length hollow rolls, such as gift wraps. For example, a user may purchase gift wrap paper that is on an extra long hollow roll. With telescoping dispenser 512, the user can simply extend the dispenser until it accommodates the roll length. Continuing with the example, if the user subsequently purchases a gift wrap paper that is shorter than the standard length, the user does not have to purchase a new container. Rather, the user can simply protract the telescoping dispenser until it accommodates the shorter hollow roll. Although the preferred structure of this embodiment is to have both the dispenser and the cutter track be telescoping, a telescoping dispenser can be used with a non-telescoping cutter track, or a non telescoping dispenser can be used with a telescoping cutter track.

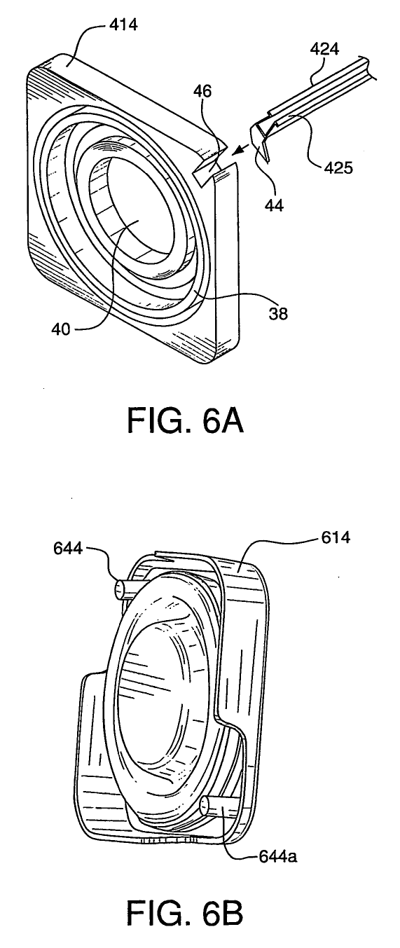

FIG. 6A shows an alternate means for accepting the cutter assembly wherein cutter track 424 comprises barded ends 44 for engaging a slot 46 in the caps 414. Cutter track 424 nests in slot 46 such that the barbed ends 44 are snugly positioned against the end cap 414 on the side opposite dispenser (not shown in FIG. 6A). The snug fit of the barbed ends substantially locks cutter track 424 into end caps 414 and preferably secures cutter track 424 adjacent to the outer surface of the dispenser.

The end caps in any of the embodiments are preferably detachable, but one or both of the end caps can be permanently engaged with the dispenser. Permanent engagement of the end caps can be accomplished by the use of adhesives or the like, and is most beneficial for one-time use containers where removal and replacement of the roll of web material is not necessary.

FIG. 6B shows a farther alternate design where a projection 644 is formed on the inwardly positioned surface of the end cap 614. As illustrated a second projection 644a is formed in the corner of the end cap 614 diagonal from the first mentioned projection 644. Either projection fits into the channel formed by the cutter track (not shown in FIG. 6B) to lock it into place. If the cutter track is secured to the dispenser (see FIG. 1A) the dispenser is also locked with respect to the corner member 614.

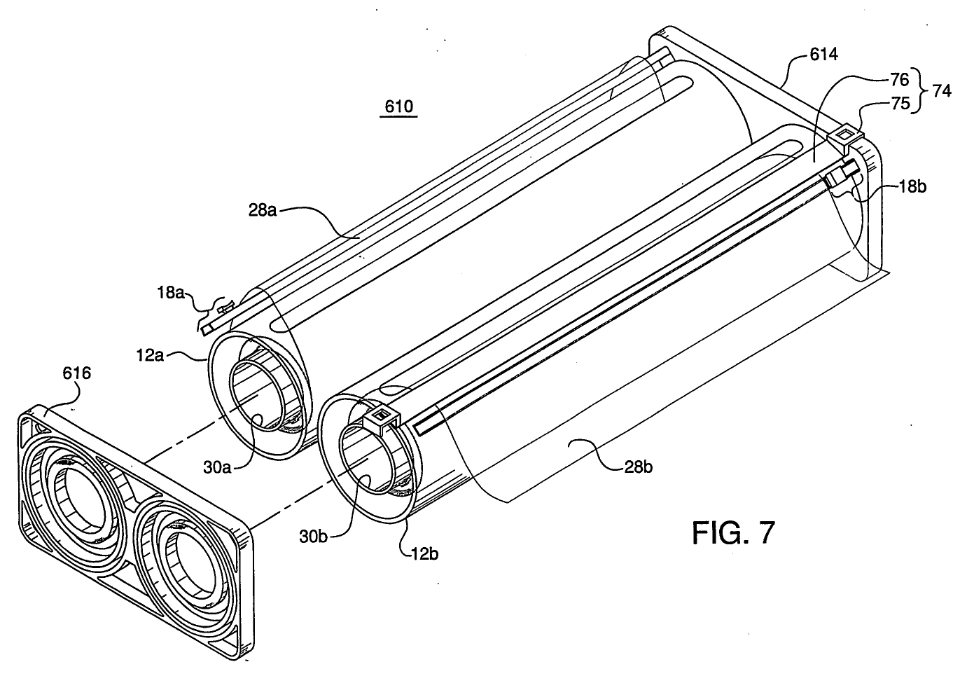

FIG. 7 shows an alternate embodiment of the container wherein two dispensers are configured in a twin pack 610. Twin pack 610 comprises two dispensers 12a, 12b, two cutter assemblies 18a, 18b engaged with dispensers 12a, 12b, and twin end caps 614, 616. The twin end caps 614, 616 as illustrated are made of single molded pieces with the same features as individual end caps 14, 16, shown for example, in FIGS. 1A, 2A and 2B, namely, having a means for accepting dispensers, a means for accepting hollow rolls, and a means for accepting cutter assembles. Thus, the twin embodiment is configured to engage two dispenser covers 12a, 12b, two hollow rolls 30a, 30b of web material 28a, 28b, and two cutter assemblies 18a, 18b. Dispensers 12a, 12b are oriented such that web material 28a within dispenser 12a is dispensed in the opposite direction from the web material 28b dispensed from dispenser 12b. It is contemplated that each dispenser of the twin pack can be used to house different types of web material. For example, the dispenser 12a may house a plastic wrap 28a and the other dispenser 12b may house an aluminum foil 28b. In another example, the dispenser 12a may house birthday gift wrap 28a and the dispenser 12b may house holiday gift wrap 28b.

The embodiment illustrated in FIG. 7 further comprises a holder 74 that immobilizes the web material during cutting and/or storage by trapping the web material against the exterior of the dispenser tube 12b. The user pulls the web material through the elongated opening. The user then places snap pieces 75 of the holder 74 over the top edge of the end caps 614, 616, such that the trapping piece 76 secures the web material 28b against the dispenser 12b. It is contemplated that the pressure exerted on the web material by trapping piece 76 can be adjusted so that the web material is completely immobilized or only partially immobilized. Partially immobilized as used herein means that the web material is substantially secured during cutting and storage, but can still be pulled between the dispenser and holder 74.

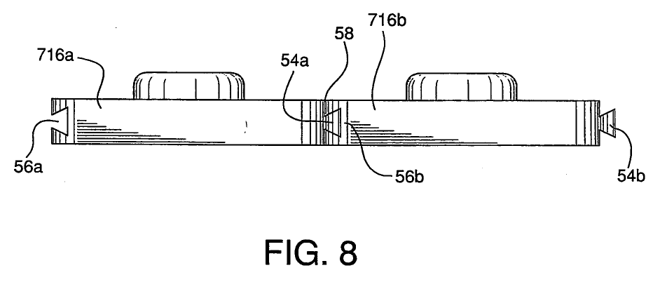

FIG. 8 shows an alternate embodiment for end caps of the twin pack, wherein two end caps are connected by way of a tongue-in-grove connectors. As illustrated, end cap 716a is engaged with end cap 716b by means of an interlocking of a male member (“tongue”) 54a with a female member (“groove”) 56b. End cap 716 may be manufactured with only a single male member 54, or with only a single female member 56. For example, end cap 716a may have male member 54a without female member 56a on its opposing surface. Further, end cap 716b may have female member 56b but not include male member 54b on the opposing surface. Alternatively, the end caps may be manufactured with two male members 54 or two female members 56.

An alternative engagement means for end cap 716a and end cap 716b is by means of an adhesive or a hook and loop fastener affixed to the engaging surface 58. It is contemplated that additional end caps may be engaged, either by the means depicted or by some other means, so as to create a triple pack, a quadruple pack, and so on.

FIGS. 9A, 9B and 9C show an alternate embodiment of the container comprising tubular dispenser 60 having a semi-circular or G-shaped profile. The end cap 814 includes a groove that accommodates the profile of the dispenser tube 60. A slot or detent is also provided on the end cap 814 for accepting the cutter assembly 18. The opening 62 formed by the profile of the dispenser 60 provides access to the web material 28 positioned on tube 80. The opening 62 is configured such that a user may reach into dispenser 60 to extract web material 28. In this embodiment, the cutter assembly 18 is positioned proximate to opening 62 to facilitate extraction of the web material 28 through opening 62 and cutting by the cutter assembly 18.

In FIG. 9B, the cutter assembly 18 is secured to the outside surface of the dispenser tube 60, proximate to the opening 62. The opening 62 is formed such that it is approximately the height of the track portion of the assembly 18. This arrangement permits the web material 28 to move easily out of the opening and be positioned on the cutter assembly for cutting.

In FIG. 9C, the cutter assembly 18 is secured to the inside edge of the dispenser 60, proximate to the opening 62. If the dispenser 60 is permitted to sufficiently flex in its position on the end caps (see 814 in FIG. 9A, for example), the inside edge rides on the surface of the web material 28. This engagement may be used to cause drag on the web material to prevent over rotation of the roll.

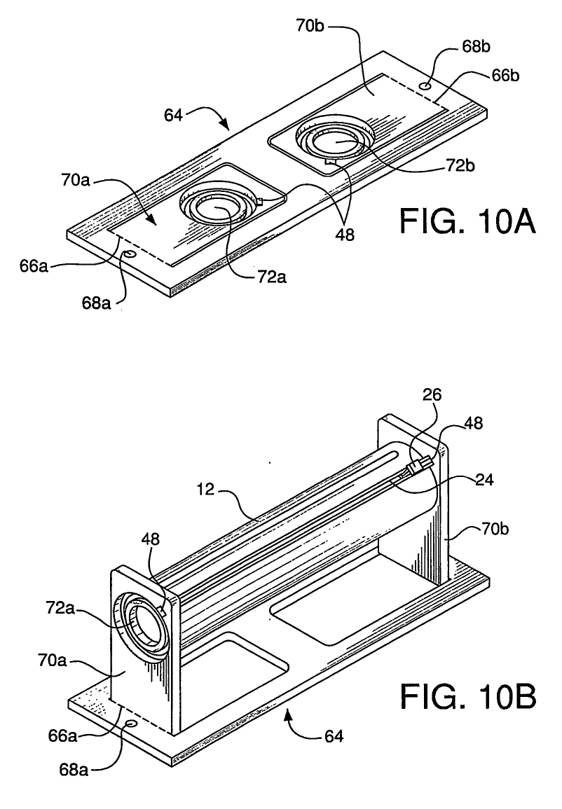

FIGS. 10A and 10B show an alternate embodiment of the container wherein dispenser 12 is held in place by a one piece molded component 64. Molded component 64, comprises hinge portions 66a, 66b, openings 68a, 68b, and end caps 70a, 70b. The hinges 66a, 66b may be integrally formed, or may be attached in any convenient manner. End caps 70a, 70b further comprise means for engaging dispenser 12, means for engaging a hollow roll of web material (not shown), and means for accepting cutter track 24 and for limiting inadvertent removal of the shearing device 26. The means for engaging dispenser 12 preferably comprises a molded groove that dispenser 12 engages creating a friction interference fit. The means for engaging a roll of web material preferably comprises protrusions 72a, 72b that engage a portion of the inner diameter of the hollow roll. The means for accepting cutter track 24 preferably comprises cutter track holders 48.

The container is assembled by rotating the end caps 70a, 70b about the hinges 66a, 66b in direction Ra, Rb. After rotation, the dispenser can engage the molded grooves and the hollow roll of web material can engage the protrusions 72a, 72b. The openings 68a, 68b can be used in combination with screws, bolts, suction cups, etc. to fix the molded component 64 to a tabletop, countertop, shelf, wall, underside of a cabinet or the like.

The container may also have a hook and loop fastener material affixed to the end caps that engages a corresponding hook and loop fastener material attached to a fixed surface. When the hook and loop fastener materials engaged the container is held in place. It is contemplated that an adhesive, adhesive strip, suction cups, or the like may also be used to attach the container to a surface.

The container may also be affixed by the use of a mounting bracket which supports the end caps and suspends the dispenser there between. The container can be positioned on upstanding flanges of the support bracket. Projections on the flanges can engage openings in the end caps to support the container longitudinally on the bracket. Openings may be provided in the bracket for positioning of suction cups, or for the receipt of mounting screws or the like, for mounting the bracket The bracket may be mounted on the undersurface of a cabinet above a typical kitchen counter. The bracket may also be positioned permanently under the cabinetry with the container being removable from between the flanges, for replacement of the supply of web material. The track is preferably projected outwardly from the container so as to provide easy access to the web material and removal of a portion of the web from the roll by means of the cutter assembly.

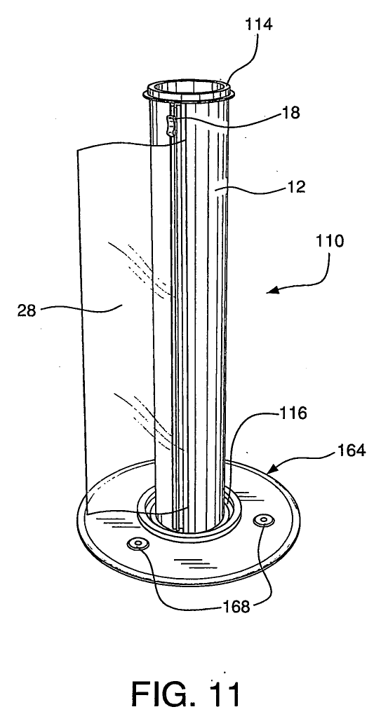

In FIG. 11, there is shown an embodiment of a container 110 with a dispensing support. The end caps 114, 116 have a rounded profile and are attached to the ends of a dispenser tube 12. This attachment is contemplated to be in the same manner as the other embodiments discussed herein. A support base 164 is provided having a central opening for receipt and engagement of one end cap 116. The fixing of one end of the container 110 to the base 164 positions the dispenser tube 12 vertically. Thus, the web material 28 may be pulled from the dispenser 12 and cut by cutting assembly 18. The base 168 is preferably locked into position on a countertop, or the like by any means desired, such as those discussed above with respect to the embodiment shown in FIGS. 10A and 10B. Openings 168 as shown may be utilized for this purpose in the same fashion as openings 68a, 68b. Further, it is contemplated that end cap 116 is fixedly secured to the dispenser tube 12 and, preferably, releasably secured to the base in any known manner, such as a snap fit relationship.

It is contemplated that one or more of the alternate embodiments may be used in combination to create further alternate embodiments. For example, a container may comprise a transparent, telescoping dispenser, and a telescoping cutter track with barbed ends.

It will be appreciated by those skilled in the art, that the present invention may be practiced in various alternate forms and configurations. The previously detailed description of the disclosed embodiments is presented for purposes of clarity of understanding only, and no unnecessary limitations should be implied there from.

We claim:

1. A container for dispensing selected portions of a web material retained on a roll, the roll being substantially hollow and having an inner diameter, the container comprising:
a substantially hollow dispenser having an elongated opening in a portion of the side wall thereof, the dispenser comprising a profile shape;
a track-guided cutting assembly comprising a shearing device and a cutter track, the cutter track having a track profile shape; and
at least one molded end cap comprising a molded groove substantially corresponding to the profile shape of the dispenser, a molded projection substantially corresponding to the inner diameter of the roll, and a cutter track holder substantially corresponding to the track profile shape of the cutter track,
wherein the at least one end cap is detachable from the dispenser, roll and track-guided cutting assembly.

2. The container of claim 1 wherein the profile shape of the dispenser is substantially circular.

3. The container of claim 1 wherein the dispenser comprises a substantially transparent plastic.

4. The container of claim 3 wherein the dispenser comprises a thick walled plastic.

5. The container of claim 1 wherein the dispenser is telescoping.

6. The container of claim 1 wherein the dispenser comprises a removable tab positioned adjacent the elongated opening.

7. The container of claim 1 wherein the at least one molded end cap comprises a substantially square profile.

8. The container of claim 1 wherein the at least one molded end cap comprises a snap-over paper holder.

9. The container of claim 1 wherein the at least one molded end cap comprises a rib capable of engagement with a notch in the dispenser.

10. The container of claim 1 wherein the cutter track is adhesively bonded to the dispenser.

11. The container of claim 1 wherein the shearing device is capable of moving along the cutter track for the length of the elongated opening.

12. The container of claim 11 wherein the shearing device comprises at least two sharp edges.

13. The container of claim 11 wherein the cutter track is engaged with the cutter track holder of the end caps, the engagement fixing the position of the cutter track relative to the dispenser.

14. The container of claim 1 wherein the cutter track comprises a styrene based elastomer co-extruded on a high impact polystyrene.

15. The container of claim 11 wherein the cutter track comprises at least one barbed end, a first end cap comprises at least one notch, and a second end cap comprises at least one notch, wherein the cutter track is positioned such that the cutter track nests in the at least one notch of the first end cap and in the at least one notch of the second end cap, wherein the at least one barbed end is positioned on the side of the end cap opposite the dispenser.

16. The container of claim 1 wherein the engagement of the profile of the dispenser and the groove of the end caps comprises a friction interference fit.

17. The container of claim 1 wherein the end caps comprise a rib and the dispenser comprises at least one notch positioned proximate to the elongated opening, wherein the rib of the end caps engages the at least one notch fixing the position of the dispenser relative to the end caps.

18. The container of claim 1 wherein two or more end caps are connected to each other.

19. The container of claim 18 wherein the end caps comprise tongue-in-groove connectors such that two or more end caps are connected via the connectors.

20. The container of claim 1 wherein the web material comprises one or more of gift wrap, decorative foil, aluminum foil, or plastic wrap.

21. The container of claim 1 wherein the container further comprises a snap-on paper holder.

22. A container for dispensing selected portions of a web material retained on a roll, the container comprising:
a hollow, substantially cylindrical dispenser having an elongated opening in a portion of the side wall thereof;
a cutter assembly positioned adjacent the elongated opening; and
a first end cap and a second end cap positioned on the dispenser, enclosing the ends of the dispenser and being capable of supporting the roll of web material and the cutter assembly;
wherein the elongated opening is capable of receiving an end of the rolled material for removal of a selected portion thereof from the roll by the cutter assembly.

23. A container for cutting select portions of a web material retained on a roll, the container comprising:
a dispenser with the roll of web material therein;
a cutter assembly positioned on the dispenser, the cutter assembly comprising a cutter track and a shearing device; and
end caps positioned on the dispenser, enclosing the ends of the dispenser, the end caps comprising a molded material comprising a detent substantially corresponding to the profile shape of the cutter track, a groove substantially corresponding to the profile shape of the dispenser, and a protrusion for accepting a roll of material;
wherein the select portion of the web material is removed from the dispenser and cut with the cutter assembly.

24. The container of claim 23 wherein the end caps comprise a portion of a one piece molded component.
